(19) United States
(12) Patent Application Publication
(10) Pub. No.: US 2019/0308469 A1
(43) Pub. Date: Oct. 10, 2019

(54) TIRE WITH INVERSE CASING CONSTRUCTION

(71) Applicant: Specialized Bicycle Components, Inc., Morgan Hill, CA (US)

(72) Inventors: Oliver Kiesel, Morgan Hill, CA (US); Wolf vorm Walde, Morgan Hill, CA (US); Jim Yeh, Morgan Hill, CA (US)

(21) Appl. No.: 15/946,564

(22) Filed: Apr. 5, 2018

(51) Int. Cl. B60C 15/00; B60C 15/04; B60C 9/00; B60C 9/02

(52) U.S. Cl. CPC B60C 15/0072; B60C 15/04; B60C 9/0042; B60C 9/0057; B60C 1/0016; B60C 15/0018; B60C 15/0045; B60C 2015/042; B60C 2200/12; B60C 9/02

(57) ABSTRACT

A vehicle tire comprises a first casing layer spanning between and wrapping around first and second bead cores. The first casing layer has first edge sections that do not overlap with each other and stop short of a central tread region of the tire. A second casing layer has second edge sections that overlap the first edge sections of the first casing layer, and the second casing layer spans the central tread region. A tread layer spans the central tread region. A breaker belt is positioned in the central tread region between the second casing layer and the tread layer or between the first casing layer and the second casing layer. First and second sidewall regions are defined between the tread layer and the first and second bead cores, respectively. The sidewall regions comprise three plies of casing layers and the central tread region comprises two plies of casing layers.

### BACKGROUND

The present invention relates to tire construction and specifically to a bicycle tire construction having a unique casing construction.

Modern bicycle tires are typically made with multiple casing layers that overlap to create the basic body of the tire. At least one of the casing layers wraps around bead cores on either edge of the tire to define the tire beads. A tread layer is positioned on the casing layers to provide a running surface in contact with the road. A breaker belt can be provided under the tread layer to improve puncture resistance of the tire.

### SUMMARY

The present invention provides a vehicle tire comprising first and second bead cores spaced apart from each other. A first casing layer (e.g., a base casing layer) spans between the bead cores and is wrapped around the bead cores. The first casing layer has first edge sections that do not overlap with each other and stop short of a central tread region of the tire. A second casing layer (e.g., an additional casing layer) has second edge sections that overlap the first edge sections of the first casing layer, and the second casing layer spans the central tread region. A tread layer spans the central tread region. Preferably, the second casing layer does not wrap around the bead cores.

The bead cores each preferably comprise a polymeric yarn bundle comprising aramid fibers or zylon fibers. The casing layers each preferably comprise a woven cloth including nylon, cotton, or silk. The tread layer preferably comprises butyl rubber and carbon black.

The tire can further comprise a breaker belt in the central tread region. In one embodiment, the breaker belt is positioned between the second casing layer and the tread layer, and in another embodiment the breaker belt is positioned between the first casing layer and the second casing layer.

In the disclosed tire construction, first and second sidewall regions are defined between the tread layer and the first and second bead cores, respectively. The sidewall regions comprise three plies of casing layers and the central tread region comprises two plies of casing layers. For example, the three plies can be made up of two plies of the first casing layer and one ply of the second casing layer, and the two plies can be made up of one each of the first casing layer and the second casing layer.

Other aspects of the invention will become apparent by consideration of the detailed description and accompanying drawings.

### BRIEF DESCRIPTION OF THE DRAWINGS

FIG. 1 is a perspective view of a bicycle having tires embodying the present invention.

FIG. 2 is a flat schematic drawing of a tire construction corresponding with a first embodiment of the present invention.

FIG. 3 is a round schematic drawing of the tire construction in FIG. 2.

FIG. 4 is a flat schematic drawing of a tire construction corresponding with a second embodiment of the present invention.

FIG. 5 is a round schematic drawing of the tire construction in FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

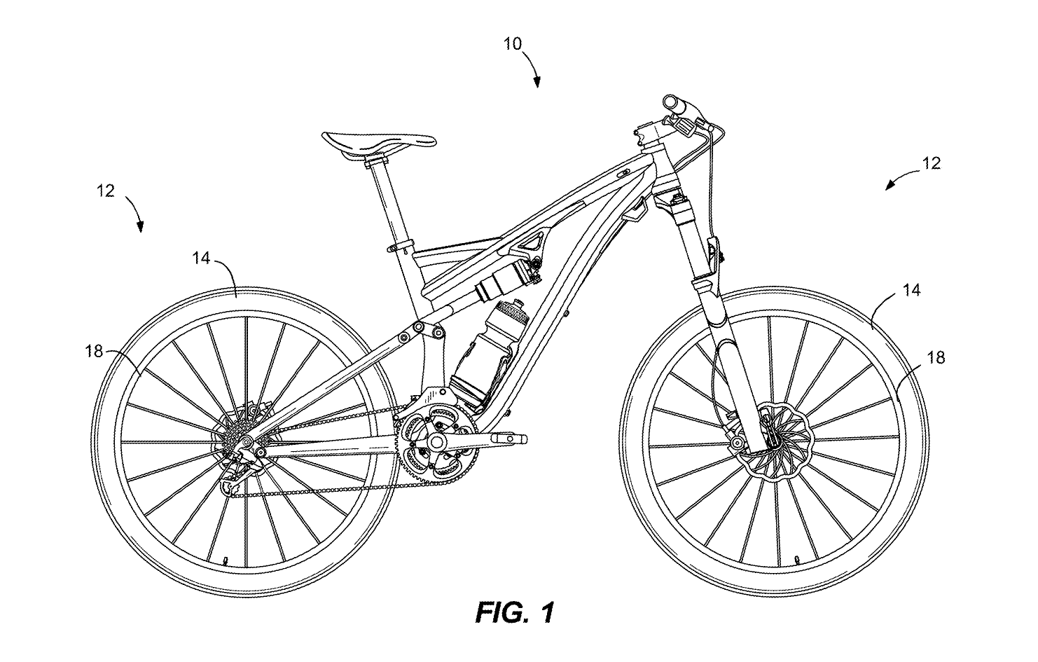

FIG. 1 illustrates a bicycle 10 including wheels 12 with tires 14 embodying the present invention. As with standard tires, the illustrated tires 14 includes typical parts, such as beads 16 (FIG. 3) that are designed to be retained in a wheel rim 18, as is known in the art. Referring to FIG. 3, the beads 16 are coupled to sidewalls 20, which lead to a tread 22.

The illustrated tires 14 have a unique layered construction using known materials. For example, the inside of the beads 16 include bead cores 24 made of wire or a polymeric yarn bundle, such as aramid, Kevlar, or Zylon fibers, or a mixed of those materials. The sidewalls 20 are formed by casing layers, described below, that similarly can be made of multiple different known casing materials, such as cloth comprising nylon, cotton or silk. Thread counts can vary, but generally are between 100 and 150 tpi. For airtightness, the casing cloth material can be embedded with rubber or resilient polymer, which is particularly beneficial when using the tire in a tubeless configuration.

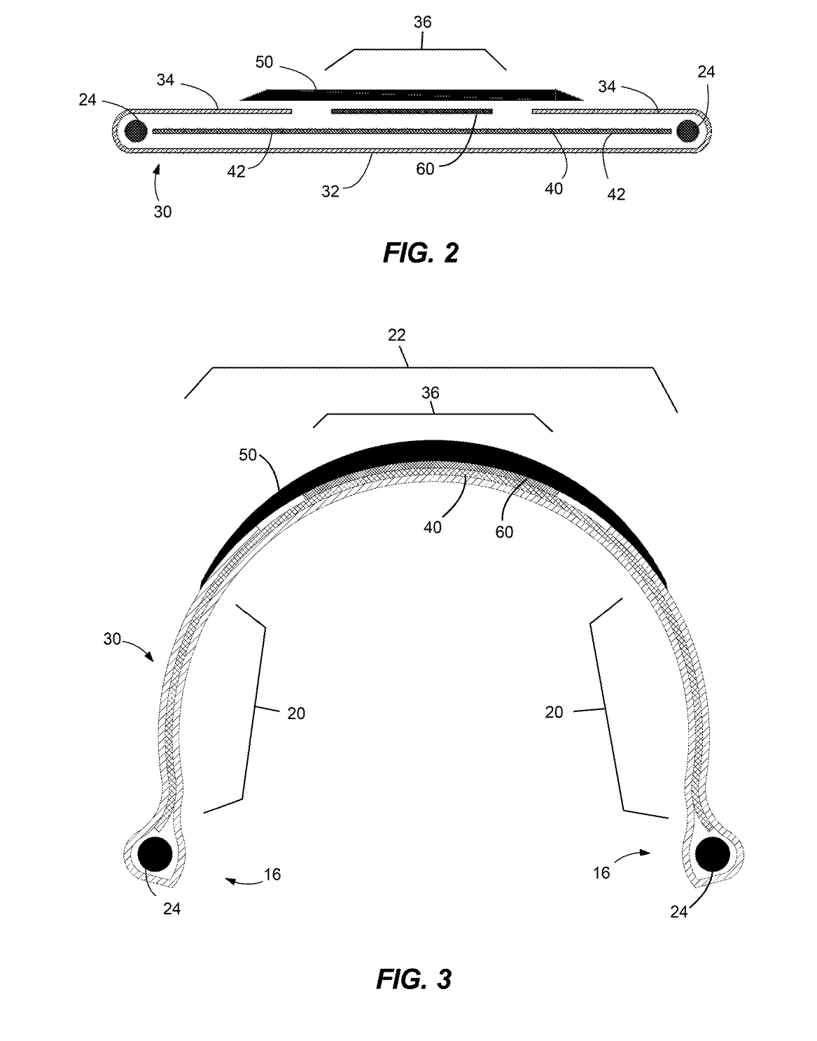

The unique layered construction of the present invention can be implemented in multiple different configurations. For example, referring to FIGS. 2-3, one such configuration utilizes a base casing layer 30 having a center section 32 that spans between the bead cores 24 and edge sections 34 that wrap around the bead cores 24. The edge sections 34 of the base casing layer 30 do not overlap with each other and stop short of a central tread region 36 of the tire 14, which is generally the region of the tread that contacts the road surface under normal operating conditions. This base casing layer 30 is a woven construction oriented at 45 degrees to the direction of travel.

An additional casing layer 40 is sandwiched between the edge sections 34 and central section 32 of the base casing layer 30. That is, the additional casing layer 40 has edge sections 42 that overlap with the edge sections 34 of the base casing layer 30. The additional casing layer 40 extends between the bead cores 24, but does not wrap around the bead cores 24. In this regard, it can be seen that the additional casing layer 40 spans the central tread region 36. This additional casing layer 40 is a woven construction oriented at 45 degrees to the direction of travel.

A tread layer 50 is positioned above and spans the central tread region 36 of the tire 14. The illustrated tread layer 50 overlaps the edge sections 34 of the base casing layer 30 by about 5-7 mm. The tread layer 50 can be made of any suitable material, such as butyl rubber mixed with carbon black and/or silicon, as is known in the art.

The illustrated tire 14 further includes a breaker belt 60 in the central tread region 36 between the tread layer 50 and the additional casing layer 40. The breaker belt 60 provides a cut-resistant layer, and can be made of a suitable mesh made from aramid, Kevlar, or Zylon and positioned at an angle of 45 degrees to the direction of travel. As shown in FIGS. 2-3, the breaker belt does not overlap with the edge sections 34 of the base casing layer 30.

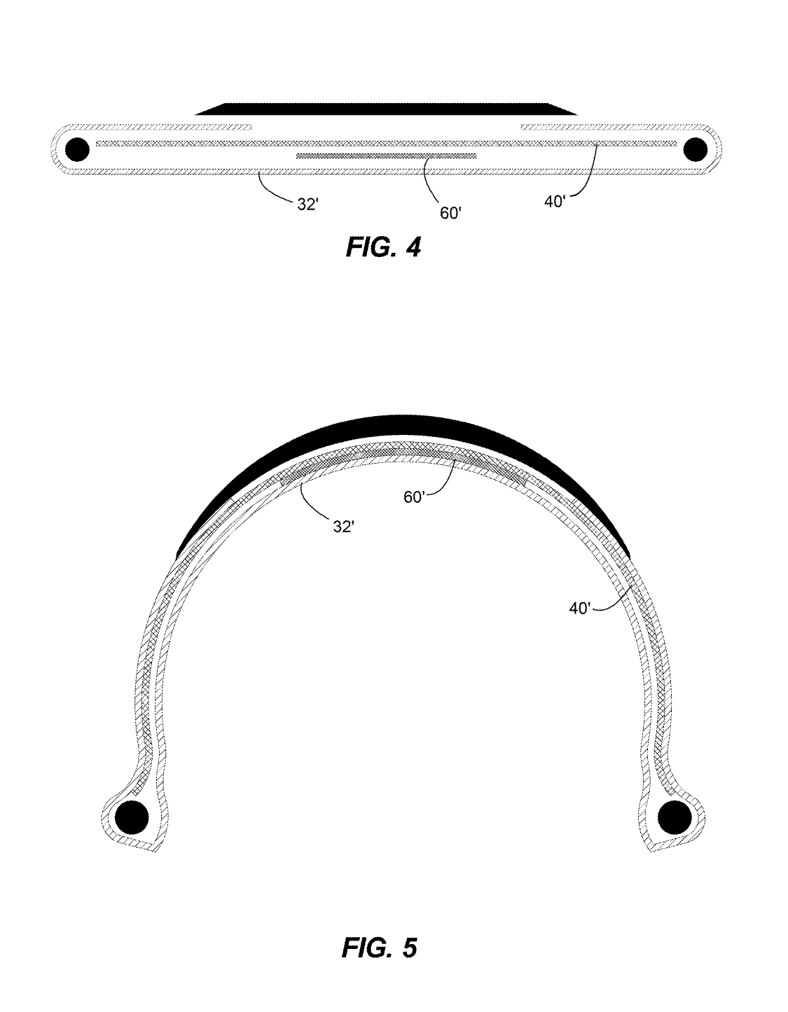

Referring to FIGS. 4-5, the breaker belt 60′ can instead be sandwiched between the center section 32′ of base casing layer and the additional casing layer 40′.

The above-described tire construction provides a tire 14 having sidewalls 20 with three plies of casing layers and a central tread region 36 with two plies of casing layers. More specifically, the three plies of each sidewall 20 are made up of two plies of the base casing layer 30 (i.e., the center section 32 and the edge sections 34) and one ply of the additional casing layer 40. The two plies of the central tread region 36 are made up of one each of the center section 32 of the base casing layer 30 and the additional casing layer 40. This arrangement is believed to provide low rolling resistance (due to the two-layer central tread region) combined with excellent cornering performance and sidewall integrity (due to the three-layer sidewall regions).

Various features and advantages of the invention are set forth in the following claims.

1. A vehicle tire comprising:
first and second bead cores spaced apart from each other;
a first casing layer spanning between the bead cores and wrapped around the bead cores, the first casing layer having first edge sections that do not overlap with each other and stop short of a central tread region of the tire;
a second casing layer having second edge sections that overlap the first edge sections of the first casing layer, the second casing layer spanning the central tread region; and
a tread layer spanning the central tread region.

2. A vehicle tire as claimed in claim 1, wherein the bead cores each include a polymeric yarn bundle comprising aramid fibers or zylon fibers.

3. A vehicle tire as claimed in claim 1, wherein the first casing layer comprises a woven cloth including nylon, cotton, or silk.

4. A vehicle tire as claimed in claim 1, wherein the second casing layer comprises a woven cloth including nylon, cotton, or silk.

5. A vehicle tire as claimed in claim 1, wherein the tread layer comprises butyl rubber and carbon black.

6. A vehicle tire as claimed in claim 1, further comprising a breaker belt in the central tread region.

7. A vehicle tire as claimed in claim 6, wherein the breaker belt is positioned between the second casing layer and the tread layer.

8. A vehicle tire as claimed in claim 6, wherein the breaker belt is positioned between the first casing layer and the second casing layer.

9. A vehicle tire as claimed in claim 1, wherein the second casing layer does not wrap around the bead cores.

10. A vehicle tire as claimed in claim 1, wherein first and second sidewall regions are defined between the tread layer and the first and second bead cores, respectively, and wherein the sidewall regions comprise three plies of casing layers and the central tread region comprises two plies of casing layers.

11. A vehicle tire as claimed in claim 10, wherein the three plies are made up of two plies of the first casing layer and one ply of the second casing layer, and wherein the two plies are made up of one each of the first casing layer and the second casing layer.
